(19) United States
(12) Patent Application Publication
(10) Pub. No.: US 2016/0292164 A1
(43) Pub. Date: Oct. 6, 2016

(54) EFFICIENT DATABASE MANAGEMENT

(71) Applicant: International Business Machines Corporation, Armonk, NY (US)

(72) Inventors: Pravin K. Kedia, Mumbai (IN); Sudhir B. Titirmare, Pune (IN)

(21) Appl. No.: 14/674,464

(22) Filed: Mar. 31, 2015

(51) Int. Cl. G06F 17/30

(52) U.S. Cl. CPC G06F 17/3056; G06F 17/30345

(57) ABSTRACT

An approach for efficient database management is provided. The approach searches, by one or more computer processors, for one or more databases. The approach determines a database version and a database level for each of the one or more databases. The approach loads one or more sets of commands for each of the one or more databases based, at least in part, on the database version and the database level for each of the one or more databases. The approach receives one or more command selections for each of the one or more databases. The approach generates one or more target commands based, at least in part, on the one or more command selections for each of the one or more databases. The approach determines whether to execute each of the one or more target commands locally.

### BACKGROUND OF THE INVENTION

The present invention relates generally to database technologies, and more particularly to efficient database management.

In today's competitive information technology (IT) market, many companies are focusing on how to reduce cost, increase productivity, achieve a higher return on investment, and increase ease of use of IT systems. Most companies are dependent on some of the major database technologies, each having multiple databases. A challenge faced by the IT industry is job attrition as it relates to experienced database developers for critical applications.

### SUMMARY

Aspects of an embodiment of the present invention disclose a method, a computer system, and a computer program product for efficient database management, in accordance with an embodiment of the present invention. The method includes searching, by one or more computer processors, for one or more databases. The method includes determining, by one or more computer processors, a database version and a database level for each of the one or more databases. The method includes loading, by one or more computer processors, one or more sets of commands for each of the one or more databases based, at least in part, on the database version and the database level for each of the one or more databases. The method includes receiving, by one or more computer processors, one or more command selections for each of the one or more databases. The method includes generating, by one or more computer processors, one or more target commands based, at least in part, on the one or more command selections for each of the one or more databases. The method includes determining, by one or more computer processors, whether to execute each of the one or more target commands locally.

### BRIEF DESCRIPTION OF THE DRAWINGS

FIG. 1 is a functional block diagram illustrating a data processing environment, generally designated 100, in accordance with an embodiment of the present invention.

FIG. 2 is a functional block diagram illustrating the steps of a big data program, such as the big data program of FIG. 1, generally designated 200, for efficient database management, in accordance with an embodiment of the present invention.

FIG. 3 is a block diagram depicting components of a data processing system (such as server 104 of FIG. 1), generally designated 300, in accordance with an embodiment of the present invention.

### DETAILED DESCRIPTION

Embodiments of the present invention provide the capability to automatically discover a database operating over a network without prior knowledge of inputs from end users through a big data server. Embodiments of the present invention further provide the capability to handle database development and database administration tasks for a plurality of databases (i.e., heterogeneous databases) by converting generic language text to database specific command instructions without prior knowledge of a type of each specific database in the plurality of databases utilizing a network. Embodiments of the present invention further provide the capability to handle different database versions for each specific database in the plurality of databases, generating commands for each database and optionally executing the commands. Embodiments of the present invention further provide the capability to educate end users on considerations, benefits, and impacts related to executing the commands.

Implementation of such embodiments may take a variety of forms, and exemplary implementation details are discussed subsequently with reference to the Figures.

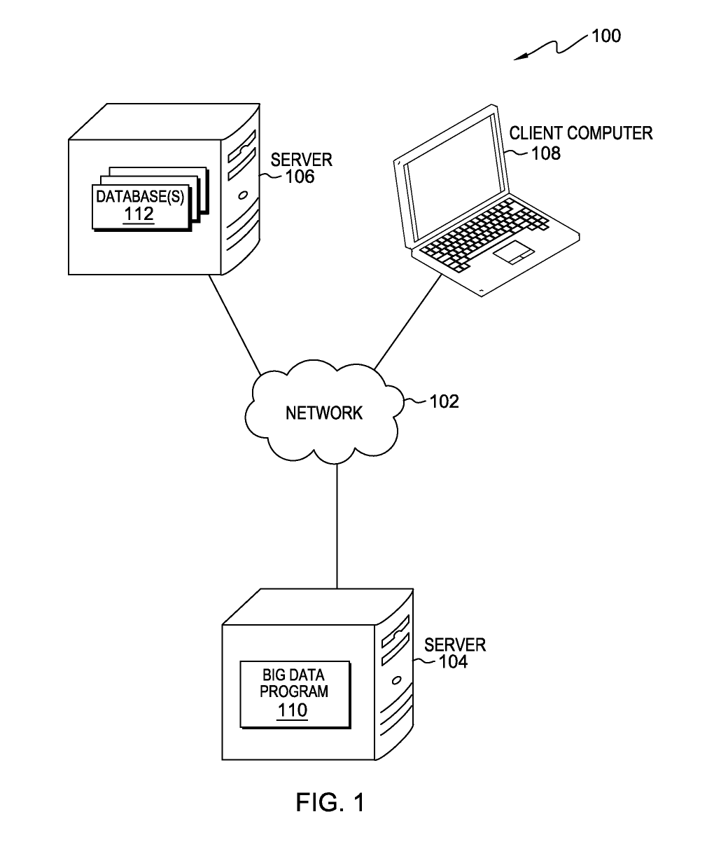

The present invention will now be described in detail with reference to the Figures. FIG. 1 is a functional block diagram illustrating a data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. FIG. 1 includes network 102, server 104, server 106, and client computer 108.

In the exemplary embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, server 106, and client computer 108 are interconnected by network 102. Network 102 can be any combination of connections and protocols capable of supporting communications between server 104, server 106, client computer 108, and big data program 110. Network 102 may also be implemented as a number of different types of networks, such as an intranet, a local area network (LAN), a virtual local area network (VLAN), or a wide area network (WAN). FIG. 1 is intended as an example and not as an architectural limitation for the different embodiments.

In the exemplary embodiment, server 104 may be, for example, a server computer system such as a management server, a web server, or any other electronic device or computing system capable of sending and receiving data. In another embodiment, server 104 may be a data center, consisting of a collection of networks and servers providing an IT service, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In the exemplary embodiment, server 104 includes big data program 110 for efficient database management on a client machine, such as server 106 and client computer 108.

In the exemplary embodiment, server 106 may be, for example, a server computer system such as a management server, a web server, or any other electronic device or computing system capable of sending and receiving data. In another embodiment, server 106 may be a data center, consisting of a collection of networks and servers providing an IT service, such as virtual servers and applications deployed on virtual servers, to an external party. In another embodiment, server 106 represents a “cloud” of computers interconnected by one or more networks, where server 106 is a computing system utilizing clustered computers and components to act as a single pool of seamless resources when accessed through network 102. This is a common implementation for data centers in addition to cloud computing applications. In the exemplary embodiment, server 106 includes database(s) 112 for storing data.

In the exemplary embodiment, big data program 110 operates on a central server, such as server 104, and can be utilized by one or more client machines, such as server 106 and client computer 108, via network 102. In another embodiment, big data program 110 may be a software-based program downloaded from the central server, such as server 104, or a third-party provider (not shown), and executed on a client machine, such as client computer 108 to efficiently manage database development and administration on a second client machine, such as server 106. In another embodiment, big data program 110 may be a software-based program, downloaded from a central server, such as server 104, and installed on one or more client machines, such as server 106 and client computer 108. In yet another embodiment, big data program 110 may be utilized as a software service provided by a third-party cloud service provider (not shown).

In the exemplary embodiment, big data program 110 is a software-based program for efficient database management. In the exemplary embodiment, big data program 110 provides the capability for a user (e.g., a database administrator, database developer, etc.) to detect backend databases automatically on a client machine, such as database(s) 112 of server 106 without internet protocol (IP) and port number inputs from the user. Big data program 110 provides the capability for the user to work efficiently with multiple database technology without a need to learn new syntaxes. In the exemplary embodiment, big data program 110 provides database specific commands for multiple databases within a command library. In the exemplary embodiment, big data program 110 generates target commands for multiple databases. In some embodiments, big data program 110 executes the target commands for the user. In one embodiment, big data program 110 provides the capability to handle new functionality, as well as deprecated functionality, related to multiple database technology. In one embodiment, big data program 110 provides the capability to handle heterogeneous databases, including both structured and unstructured databases.

In the exemplary embodiment, client computer 108 is a client to server 104 and may be, for example, a desktop computer, a laptop computer, a tablet computer, a personal digital assistant (PDA), a smart phone, a thin client, or any other electronic device or computing system capable of communicating with server 104 through network 102. For example, client computer 108 may be a laptop computer capable of connecting to a network, such as network 102, to perform database development and administration tasks on one or more databases on a client machine, such as database(s) 112 of server 106, and communicate with a central server to utilize a software-based program, such as big data program 110 of server 104. In one embodiment, client computer 108 may be any suitable type of mobile device capable of running mobile applications, including a smart phone, tablet, slate, or any type of device that runs a mobile operating system.

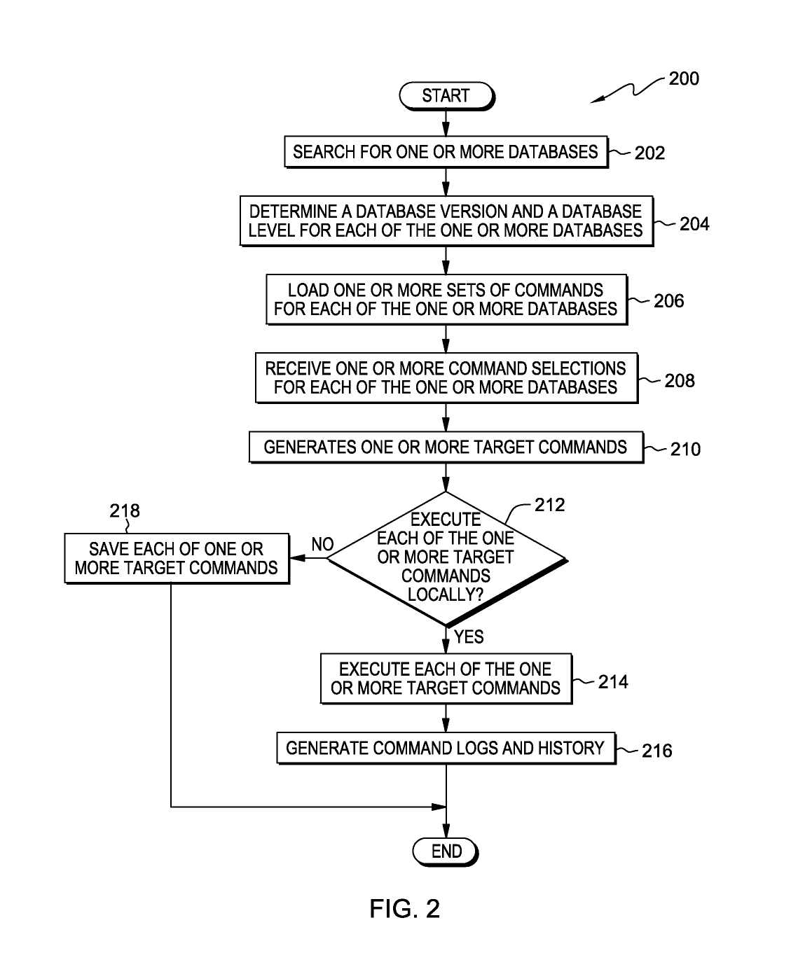

FIG. 2 depicts a flowchart of the steps of a big data program, such as big data program 110 of FIG. 1, generally designated 200, for efficient database management, in accordance with an embodiment of the present invention.

Big data program 110 searches for one or more databases (202). In the exemplary embodiment, big data program 110 searches for one or more available databases on a client machine, such as database(s) 112 of server 106, wherein searching for the one or more available databases includes retrieving information from the one or more databases. In one embodiment, big data program 110 may receive a request from a client machine responsible for database development and administration, such as client computer 108, to search for one or more available databases on a client machine, such as server 106. In the exemplary embodiment, big data program 110 searches for one or more available databases, such as database(s) 112, by detecting operating system (OS) processes executing locally on a client machine, such as server 106. For example, big data program 110 searches for one or more databases by detecting run level processes running in the background of an OS from, for example, “ps-aef” commands and various database specific processes. In one embodiment, big data program 110 retrieves one or more database identifiers, such as detectible database specific processes, detectible database specific commands, configuration specific files, administration commands, etc., from the one or more available databases. In one embodiment, big data program 110 searches for one or more databases utilizing a detection method, similar to a Wi-Fi detection method, to detect active databases as the one or more database become available. In one embodiment, big data program 110 searches for one or more databases and database products over various types of networks, including, but not limited to, an intranet, a LAN, a VLAN, or a WAN. In one embodiment, where big data program 110 does not locate an available database on a client machine, big data program 110 stops searching for one or more databases and ends processing.

Big data program 110 determines a database version and a database level for each of the one or more databases (204). In the exemplary embodiment, big data program 110 determines a database version and a database level for each of the one or more databases within a client machine, such as database(s) 112 of server 106, by matching one or more database identifiers, such as detectible database specific processes and database specific commands, with characteristics of known database technology. For example, big data program 110 may determine that detectible database specific processes and commands associated with a found database (e.g., configuration specific files, commands, etc.) match characteristics of a database technology, such as DB2® 10.1 Fix 2. In the exemplary embodiment, big data program 110 includes an internal catalog for storing various known database technologies, along with specific characteristics of the known database technologies. In one embodiment, big data program 110 determines a database version and a database level for each of the one or more databases without performing configurations, such as data source configurations, driver configurations, or connection settings.

Big data program 110 loads one or more sets of commands for each of the one or more databases (206). In the exemplary embodiment, big data program 110 loads one or more sets of commands for each of the one or more databases based, at least in part, on a database version and database level for each of the one or more databases. In the exemplary embodiment, big data program 110 searches an internal command library, where the internal library includes one or more sets of commands for various database versions and database levels of known database technology, for one or more sets of commands associated with the database version and database level of each of the one or more databases. In one embodiment, big data program 110 can update the internal command library by adding new sets of commands for new database versions and database levels as they become available. For example, big data program 110 may retrieve update information related to new database versions and database levels from a network, such as network 102. In another embodiment, big data program 110 may receive update information related to new database versions and database levels as user input via a user interface. In the exemplary embodiment, big data program 110 loads each of the one or more sets of commands into a command menu selection criteria interface, where the command menu selection criteria interface provides database administration commands, with various options for each, as well as suggestions for executing the various commands (i.e., benefits and considerations for executing various commands) to a user. For example, big data program 110 may retrieve suggestions for executing the various commands from technical manuals, Internet searches, and user input of feedback and database experience. In one embodiment, the command menu selection criteria interface is a user interface, where the user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computer, GUIs were introduced in reaction to the perceived steep learning curve of command-line interfaces, which required commands to be typed on the keyboard. The actions in GUIs are often performed through direct manipulation of the graphics elements. In one embodiment, big data program 110 may load each of the one or more sets of commands locally into memory on a central server, such as sever 104, for use by a client machine, such as client computer 108. In another embodiment, big data program 110 may load each of the one or more sets of commands directly to memory on a client machine, such as client computer 108, via a network, such as network 102.

Big data program 110 receives one or more command selections for each of the one or more databases (208). In the exemplary embodiment, big data program 110 receives one or more command selections for each of the one or more databases from a plurality of suggested database administration commands, and various options associated with each of the plurality of suggested database administration commands, provided to a user in the command menu selection criteria interface. For example, a user can explore a plurality of suggested database administration commands, and various options associated with each of the plurality of suggested database administration commands, for each of the one or more databases, and select one or more commands based on the type of task the user wishes to perform (database administration, database development, database management, etc.). The suggested database administration commands, and the various options associated with each, are presented in common English (e.g., natural language) format, such that a user can evaluate benefits and considerations with executing a particular database command to aid in making database management (i.e., database development, database administration, etc.) decisions. In one embodiment, the various options associated with each of the suggested database administration commands can include an execute locally option (i.e., big data program 110 executes the one or more command selections on behalf of a user, such as client computer 108 of FIG. 1) and an execute manually option (i.e., a user, such as client computer 108, executes the one or more command selections manually).

Big data program 110 generates one or more target commands (210). In the exemplary embodiment, big data program 110 generates one or more target commands based, at least in part, on the one or more command selections for each of the one or more databases. In the exemplary embodiment, big data program 110 generates one or more target commands by converting generic (i.e., natural language) logical set commands related to the one or more command selections for each of the one or more databases into database specific instructions. In one embodiment, big data program 110 converts generic natural language text into database specific instructions without prior knowledge of native database syntaxes for each of the one or more databases. In the exemplary embodiment, big data program 110 provides the capability for a user to select one or more database commands and associated options for execution on each of the one or more databases. In one embodiment, big data program 110 generates one or more target commands (i.e., database syntaxes and set of executable commands) based, at least in part, on the one or more command selections (i.e., generic English language selection criteria).

Big data program 110 determines whether to execute each of the one or more target commands locally (decision block, 212). In the exemplary embodiment, in response to a determination that a user elects to execute the one or more target commands locally (i.e., execute a target command automatically at a central server, such as server 104), big data program 110 executes each of the one or more target commands. In the exemplary embodiment, responsive to receiving a selection of an “execute locally” option provided in the command menu selection criteria interface, big data program 110 may determine that a user elects to execute the one or more target commands locally. In another embodiment, big data program 110 may prompt a user to execute directly (i.e., user executes the one or more target commands on a client machine, such as client computer 108) or execute locally, where in response to receiving a selection of execute locally, big data program 110 determines to execute the one or more target commands locally.

In response to a determination to not execute the one or more target commands locally (NO branch, 212), big data program 110 saves each of the one or more target commands (218). In the exemplary embodiment, big data program 110 saves each of the one or more target commands in memory on a central server, such as server 104, for direct execution by a user via a client machine, such as client computer 108. In the exemplary embodiment, big data program 110 saves each of the one or more target commands such that they are readily accessible by a user for direct execution. In another embodiment, big data program 110 may prompt a user to elect to execute each of the one or more target commands locally when a user attempts to access the target commands.

In response to a determination to execute the one or more target commands locally (YES branch, 212), big data program 110 executes each of the one or more target commands (214). In the exemplary embodiment, big data program 110 executes each of the one or more target commands on behalf of a user, handling specific database development and administration commands automatically without user intervention.

Big data program 110 generates command logs and history (216). In the exemplary embodiment, big data program 110 generates command logs and history for each of the one or more target commands executed locally. The command logs and history serve as a record of target commands executed for the one or more databases.

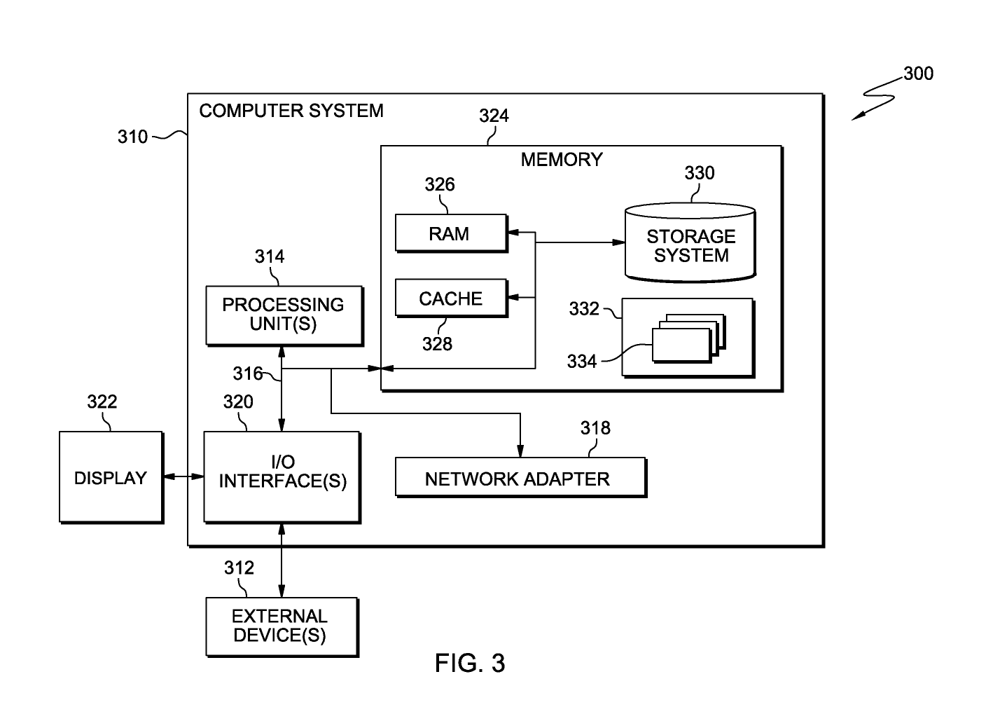

FIG. 3 depicts a block diagram of components of data processing environment 100, such as server 104 of FIG. 1, generally designated 300, in accordance with an illustrative embodiment of the present invention. It should be appreciated that FIG. 3 provides only an illustration of one implementation and does not imply any limitations with regard to the environments in that different embodiments may be implemented. Many modifications to the depicted environment may be made.

In the illustrative embodiment, server 104 in data processing environment 100 is shown in the form of a general-purpose computing device, such as computer system 310. The components of computer system 310 may include, but are not limited to, one or more processors or processing unit 314, memory 324, and bus 316 that couples various system components including memory 324 to processing unit(s) 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media may be any available media that is accessible by computer system 310, and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example, and not limitation, as well as an operating system, one or more application programs, other program modules, and program data. Each of the operating systems, one or more application programs, other program modules, and program data, or some combination thereof, may include an implementation of a networking environment. Program modules 334 generally carry out the functions and/or methodologies of embodiments of the invention as described herein. Computer system 310 may also communicate with one or more external device(s) 312 such as a keyboard, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems may be used in conjunction with computer system 310.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for database management, the method comprising:
searching, by one or more computer processors, for one or more databases;
determining, by one or more computer processors, a database version and a database level for each of the one or more databases;
loading, by one or more computer processors, one or more sets of commands for each of the one or more databases based, at least in part, on the database version and the database level for each of the one or more databases;
receiving, by one or more computer processors, one or more command selections for each of the one or more databases;
generating, by one or more computer processors, one or more target commands based, at least in part, on the one or more command selections for each of the one or more databases; and
determining, by one or more computer processors, whether to execute each of the one or more target commands locally.

2. The method of claim 1, wherein searching for one or more databases, further comprises:
detecting, by one or more computer processors, one or more active databases as the one or more active databases become available, wherein detecting the one or more active databases includes detecting one or more run level processes on a client machine.

3. The method of claim 1, wherein determining a database version and a database level for each of the one or more databases, further comprises:
matching, by one or more computer processors, one or more database identifiers with one or more characteristics of database technology, wherein the one or more characteristics of database technology are stored in an internal catalog.

4. The method of claim 1, wherein loading one or more sets of commands for each of the one or more databases, further comprises:
searching, by one or more computer processors, an internal command library for one or more sets of commands associated with the database version and the database level for each of the one or more databases, wherein the internal command library includes one or more sets of commands for a plurality of database versions and a plurality of database levels of database technology; and
loading, by one or more computer processors, the one or more sets of commands into a selection interface, wherein the selection interface includes at least one of one or more database administration commands, one or more options for each of the one or more database administration commands, and one or more suggestions for executing the one or more sets of commands.

5. The method of claim 1, wherein the one or more command selections for each of the one or more databases include one or more of:
a suggested database command, wherein the suggested database command is presented in a generic natural language format; and
an option associated with the suggested database command, wherein the option relates to execution of the suggested database command.

6. The method of claim 1, wherein generating one or more target commands, further comprises:
converting, by one or more computer processors, a generic natural language format of a suggested database command into a database specific instruction for execution on the one or more databases.

7. The method of claim 1, wherein determining whether to execute each of the one or more target commands locally, further comprises at least one of:
responsive to receiving a command selection including an option to execute locally, determining, by one or more computer processors, to execute each of the one or more target commands locally; and
responsive to receiving a command selection including an option to execute manually, determining, by one or more computer processors, to not execute each of the one or more target commands locally.

8. The method of claim 7, wherein determining to not execute the one or more target commands locally, further comprises:
saving, by one or more computer processors, each of the one or more target commands in a memory on a central server.

9. The method of claim 7, wherein determining to execute the one or more target commands locally, further comprises:
executing, by one or more computer processors, the one or more target commands locally, wherein executing the one or more target commands locally includes executing without user intervention; and
generating, by one or more computer processors, one or more command logs for each of the one or more target commands executed locally.

10. A computer program product for database management, the computer program product comprising:
one or more computer readable storage media and program instructions stored on the one or more computer readable storage media, the program instructions comprising:
program instructions to search, by one or more computer processors, for one or more databases;
program instructions to determine, by one or more computer processors, a database version and a database level for each of the one or more databases;
program instructions to load, by one or more computer processors, one or more sets of commands for each of the one or more databases based, at least in part, on the database version and the database level for each of the one or more databases;
program instructions to receive, by one or more computer processors, one or more command selections for each of the one or more databases;
program instructions to generate, by one or more computer processors, one or more target commands based, at least in part, on the one or more command selections for each of the one or more databases; and
program instructions to determine, by one or more computer processors, whether to execute each of the one or more target commands locally.

11. The computer program product of claim 10, wherein program instructions to search for one or more databases, further comprises:
program instructions to detect, by one or more computer processors, one or more active databases as the one or more active databases become available, wherein detecting the one or more active databases includes detecting one or more run level processes on a client machine.

12. The computer program product of claim 10, wherein program instructions to determine a database version and a database level for each of the one or more databases, further comprises:
program instructions to match, by one or more computer processors, one or more database identifiers with one or more characteristics of database technology, wherein the one or more characteristics of database technology are stored in an internal catalog.

13. The computer program product of claim 10, wherein program instructions to load one or more sets of commands for each of the one or more databases, further comprises:
program instructions to search, by one or more computer processors, an internal command library for one or more sets of commands associated with the database version and the database level for each of the one or more databases, wherein the internal command library includes one or more sets of commands for a plurality of database versions and a plurality of database levels of database technology; and
program instructions to load, by one or more computer processors, the one or more sets of commands into a selection interface, wherein the selection interface includes at least one of one or more database administration commands, one or more options for each of the one or more database administration commands, and one or more suggestions for executing the one or more sets of commands.

14. The computer program product of claim 10, wherein the one or more command selections for each of the one or more databases include one or more of:
a suggested database command, wherein the suggested database command is presented in a generic natural language format; and
an option associated with the suggested database command, wherein the option relates to execution of the suggested database command.

15. The computer program product of claim 10, wherein program instructions to generate one or more target commands, further comprises:
program instructions to convert, by one or more computer processors, a generic natural language format of a suggested database command into a database specific instruction for execution on the one or more databases.

16. A computer system for database management, the computer system comprising:
one or more computer readable storage media;
program instructions stored on at least one of the one or more computer readable storage media for execution by at least one of the one or more computer processors, the program instructions comprising:
program instructions to search, by one or more computer processors, for one or more databases;
program instructions to determine, by one or more computer processors, a database version and a database level for each of the one or more databases;
program instructions to load, by one or more computer processors, one or more sets of commands for each of the one or more databases based, at least in part, on the database version and the database level for each of the one or more databases;
program instructions to receive, by one or more computer processors, one or more command selections for each of the one or more databases;
program instructions to generate, by one or more computer processors, one or more target commands based, at least in part, on the one or more command selections for each of the one or more databases; and
program instructions to determine, by one or more computer processors, whether to execute each of the one or more target commands locally.

17. The computer system of claim 16, wherein program instructions to determine whether to execute each of the one or more target commands locally, further comprises at least one of:
responsive to receiving a command selection including an option to execute locally, program instructions to determine, by one or more computer processors, to execute each of the one or more target commands locally; and
responsive to receiving a command selection including an option to execute manually, program instructions to determine, by one or more computer processors, to not execute each of the one or more target commands locally.

18. The computer system of claim 17, wherein program instructions to determine to not execute the one or more target commands locally, further comprises:
program instructions to save, by one or more computer processors, each of the one or more target commands in a memory on a central server.

19. The computer system of claim 17, wherein program instructions to determine to execute the one or more target commands locally, further comprises:
program instructions to execute, by one or more computer processors, the one or more target commands locally, wherein executing the one or more target commands locally includes executing without user intervention; and
program instructions to generate, by one or more computer processors, one or more command logs for each of the one or more target commands executed locally.

20. The computer system of claim 16, wherein program instructions to search for one or more databases, further comprises:
program instructions to detect, by one or more computer processors, one or more active databases as the one or more active databases become available, wherein detecting the one or more active databases includes detecting one or more run level processes on a client machine.
